(19) United States
(12) Patent Application Publication
(10) Pub. No.: US 2008/0189351 A1
(43) Pub. Date: Aug. 7, 2008

(54) NETWORK SYSTEM WHICH PERFORMS PEER-TO-PEER COMMUNICATION

(76) Inventors: Shigeyuki Nemoto, Kawasaki (JP); Takahiro Fujishiro, Yokohama (JP); Ayumi Kawano, Tokyo (JP); Keiji Morita, Wako (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/849,554

(22) Filed: Sep. 4, 2007

(30) Foreign Application Priority Data
Jan. 24, 2007 (JP) 2007-013546

(51) Int. Cl. G06F 15/16

(52) U.S. Cl. 709/201

(57) ABSTRACT

To reduce a load inflicted on a network by peer-to-peer communication between terminals, the present invention provides a network system having a communication destination machine and a communication source machine, in which: the communication destination machine includes a unit which registers its own location information in a peer-to-peer network; and the communication source machine includes: a unit which searches the peer-to-peer network for the location information of the communication destination machine and obtains the location information; and a unit which uses the obtained information to establish peer-to-peer communication. The location information contains communication path information which enables the communication source machine to communicate with a desired machine beyond a path controller, and a parameter necessary for communication. The communication source machine may include a unit which accumulates location information or similar data of multiple communication destination machines.

### INCORPORATION BY REFERENCE

This application claims priority based on a Japanese patent application, No. 2007-013546 filed on Jan. 24, 2007, the entire contents of which are incorporated herein by reference.

### BACKGROUND OF THE INVENTION

The present invention relates to a network system capable of secure peer-to-peer communication among multiple information terminals coupled to a network.

As the Internet becomes common and the communication line speed grows faster, an increasing demand has been created for exchange of information through peer-to-peer communication between a personal computer (PC) or a terminal with a telephone function and another PC or terminal with a telephone function on a remote site over a network.

To establish communication between terminals over a network, a communication source terminal which initiates a communication session needs to have the IP address or other location information of a communication destination terminal which is on the other end of the communication session.

The communication source terminal can have various functions to obtain the location information of the communication destination terminal, one of which is to make an inquiry to a server that manages location information. In this method, a server managing location information accumulates the location information of multiple terminals. The communication source terminal makes an inquiry to the server managing location information about the location information of the communication destination terminal, and the server managing location information responds to the inquiry. The communication source terminal thus obtains the location information of the communication destination terminal.

Another way to obtain the location information of the communication destination terminal is peer-to-peer network technology in which the communication source terminal is informed of the location information of the communication destination terminal not by a server managing location information but through cooperation of terminals on the network. In peer-to-peer network technology, the communication source terminal searches for the communication destination terminal using a search key which represents characteristics or the like of the communication destination terminal, and obtains the location information of the communication destination terminal. Practical examples of peer-to-peer network technology include a method that uses Distributed Hash Table (DHT) (see I. Stoica, R. Morris, D. Karger, M. F. Kaashoek and H. Balakrishnan, “Chord: A scalable peer-to-peer lookup service for Internet applications”, Proc. ACMSIGCOMM 2001, San Diego, Calif., USA, 2001), and a method discussed in Japanese Patent Laid-open Publication No. 2004-318594 (hereinafter referred to as Document 1) and Takashige Hoshiai et al., “Performance Evaluation on Brokerless Networking Architecture” IEICE Transactions on Information and Systems Vol. J88-D-1, Number 11, November 2005 (hereinafter referred to as Document 2).

In the method using DHT, multiple terminals on the network keep a hash table. A hash table is a table in which certain information a and a search key k linked to the information a form a pair, and the pair is associated with a hash address H(k) obtained by applying a hash function H( ) to the search key k. To search for the information a, the hash table is looked up for the hash address H(k) with the use of the search key k and the hash function H( ), and the objective information a is thus obtained. What is specific to DHT is that each terminal coupled to a network holds a part of a hash table so that one hash table is formed by the entire network through cooperation of the terminals.

Chord, which is one of DHT protocols, uses SHA-1 as the hash function H( ), and applies the hash function H( ) to a search key linked to certain information and the IP address or other location information of a terminal to map the search key and the location information onto a hash space. Each terminal can know which terminal has a location information hash value that is close to its own location information hash value on the hash space. Each terminal serves as a keeper of a search key that is mapped in an area with a hash value larger than that of a terminal that ranks immediately below itself when sorted in descending order of hash value and equal to or smaller than its own hash value. Specifically, each terminal holds a part of a hash table that is relevant to its assigned area and keeps information that is linked to a search key in the area.

When a terminal receives a search request issued by a communication source terminal based on the hash value of a search key and finds that the hash value contained in the search request is outside of its assigned area, the terminal transfers the search request to a proximate terminal whose hash value is closer to the contained hash value. The search request is repeatedly transferred in this manner and ultimately reaches a terminal that is responsible for the hash value of the search key, at which point a hash table of this terminal is looked up. As a result information linked to the search key is sent as the search result to the communication source terminal.

In the case where the information linked to the search key is the location information of the communication destination terminal, the communication source terminal can obtain the location information of the communication destination terminal by searching along the peer-to-peer network using the search key, and can thus start peer-to-peer communication with the communication destination terminal.

Document z and Document 2 describe a method in which a terminal belonging to multiple groups at the same time discloses information of one of the groups (e.g., the name of the group and a keyword indicating characteristics of the group) to another group to perform peer-to-peer communication by cooperation among the groups (hereinafter referred to as “inter-group cooperation method”). Now let us show a simple procedure taken by an arbitrary terminal to join a peer-to-peer (P2P) network and find an objective communication destination terminal. FIG. 13 illustrates a configuration relevant to this procedure.

First, a terminal (hereinafter referred to as terminal H) searches for a reference of a base terminal. A base terminal is a terminal chosen as a representative from among a group that is an aggregation of terminals. The terminal H, which needs to access the base terminal, can employ various methods to accomplish the access, including obtaining the location information of a specific terminal from a third party to obtain the location information of the base terminal from the specific terminal. When the base terminal is found, the terminal H joins a group ω which is an aggregation of base terminals via the found base terminal. The terminal H then searches for a group that suits itself by sending an inquiry containing a search key to base terminals that constitute the group ω. The terminal H joins the found group (hereinafter referred to as group Y) via the representative terminal of this group (here, a base terminal F which is the representative of the group Y).

As a member of the group Y, the terminal H discloses its own identification information H and a keyword h about itself in the group Y. The newly disclosed identification information H and the keyword h of the terminal H are made available to members of the group Y (the terminal F and a terminal G).

Upon disclosure of the identification information H and the keyword h in the group Y, the base terminal F serving as the representative of the group Y discloses the identification information H and the keyword h of the terminal H to members of the group ω (a base terminal B and a base terminal D), another group to which the base terminal F belongs. The base peers thus share the same information. At this point, if a terminal A conducts a search in a group a with the keyword h as a search key word, the terminal H linked to the keyword h can be found through the base terminal B, which is the representative of the group a.

In a community formed from multiple terminals, communication between the terminals should be secured by keeping information that is communicated confidential to the terminals within the community and by preventing tampering of the information communicated. The community allows a new terminal to join and a member terminal to leave the community.

For inter-terminal communication, a communication source terminal which initiates a communication session has to have the location information of a communication destination terminal which is on the other end of the communication session. One of functions that the communication source terminal can have to obtain the location information of the communication destination terminal is to make an inquiry to a server that manages location information. This method requires construction and running of the server managing location information, thus imposing a heavy burden on the community members in the form of the server construction/running cost and the need to decide who takes charge in running the server.

Another way to obtain the location information of the communication destination terminal is the above-described peer-to-peer network technology. Peer-to-peer network technology does not need a server that manages location information.

Peer-to-peer communication herein refers to communication conducted between terminals with the use of peer-to-peer network technology, and includes a case in which a path controller transfers or examines data communicated between terminals.

### SUMMARY OF THE INVENTION

Problems to be solved by the present invention areas follows:

A first problem is that the load on the network is heavy when too many terminals simultaneously participate in negotiation of secure communication parameters for secure peer-to-peer communication between terminals.

To secure peer-to-peer communication between terminals, parameters necessary for secure communication (hereinafter referred to as secure communication parameters. Passwords and public key certificates are listed as examples of secure communication parameters) are negotiated after the communication source terminal obtains the location information of the communication destination terminal using peer-to-peer network technology and starts peer-to-peer communication. Some cases of document exchange, audio/video communication, and the like also require negotiation between terminals about other parameters than secure communication parameters (hereinafter referred to as video-, audio- or other communication parameters). Since discussed herein is communication within a community and the same community members communicate with each other more than once, it is inefficient to conduct the negotiation each time, which constitutes a second problem.

In the case where a machine that controls communication (hereinafter referred to as path controller), for example, a proxy server, a Fire Wall (FW), or a Network Address Translation (NAT) machine, is interposed between the communication source terminal and the communication destination terminal, the terminals need information that enables communicated data to pass through the interposed device (hereinafter referred to as communication path information. Examples of communication path information include a password or other confidential information to access the proxy server, and information used to manage the location information within a private network of the communication destination terminal for passing through the NAT machine and the destination terminal's location information in a network outside the NAT machine). Then the location information of the communication destination terminal obtained by the communication source terminal with the use of peer-to-peer network technology is not enough to enable the communication source terminal to access the communication destination terminal. The terminals therefore cannot establish peer-to-peer communication, which constitutes a third problem.

New techniques are thus sought to solve the above problems.

According to a first aspect of the present invention, there is provided a network system having a communication destination machine and a communication source machine that can utilize peer-to-peer network technology, in which: the communication destination machine includes a unit which registers at least location information of the communication destination machine as location information or similar data in a peer-to-peer network; and the communication source machine includes: a unit which searches the peer-to-peer network for the location information or similar data of the communication destination machine and obtains the location information or similar data; and a unit which uses the obtained information to establish peer-to-peer communication.

According to a second aspect of the present invention, there is provided a network system having a communication destination machine and a communication source machine that can utilize peer-to-peer network technology, in which: the communication destination machine is out of a peer-to-peer network; in place of the communication destination machine, a machine that can utilize peer-to-peer network technology registers at least location information of the communication destination machine as location information or similar data in the peer-to-peer network; and the communication source machine includes: a unit which searches the peer-to-peer network for the location information or similar data of the communication destination machine and obtains the location information or similar data; and a unit which uses the obtained information to establish peer-to-peer communication.

The location information or similar data includes communication path information (e.g., IP address), which enables data to be communicated to a desired machine beyond a path controller, and parameters necessary for communication (e.g., an encryption algorithm for secure communication, key information, the bit rate in video communication, the frame rate, and information encoded to be shared on an application program (information about “scent” when the application program is to handle “scent”)).

The communication source machine may have a unit which accumulates location information or similar data of multiple communication destination machines.

According to the present invention, the load inflicted on a network by secure peer-to-peer communication between terminals can be lightened. The present invention also makes peer-to-peer communication possible despite path control, and improves the efficiency of peer-to-peer communication in a community where the same members are likely to communicate with each other more than once.

These and other benefits are described throughout the present specification. A further understanding of the nature and advantages of the invention may be realized by reference to the remaining portions of the specification and the attached drawings.

### BRIEF DESCRIPTION OF THE DRAWINGS

In the accompanying drawings:

FIG. 1 is a schematic configuration diagram of a network system to which an embodiment of the present invention is applied;

FIG. 2 is a hardware configuration diagram of machines that constitute the network system;

FIG. 3 is a schematic configuration diagram of a network system to which an embodiment of the present invention is applied;

FIG. 4 is a diagram illustrating exchange of information between devices;

FIG. 5 is a diagram illustrating exchange of information between devices;

FIG. 6 is a diagram illustrating exchange of information between devices;

FIG. 7 is a diagram illustrating exchange of information between devices;

FIG. 8 is a diagram illustrating exchange of information between devices;

FIG. 9 is a diagram illustrating exchange of information between devices;

FIG. 10 is a hardware configuration diagram of machines that constitute a network system;

FIG. 11 is a diagram illustrating exchange of information between devices;

FIG. 12 is a diagram illustrating exchange of information between devices; and

FIG. 13 is a diagram illustrating a procedure that is taken by a terminal to join a peer-to-peer network and to find an objective communication terminal.

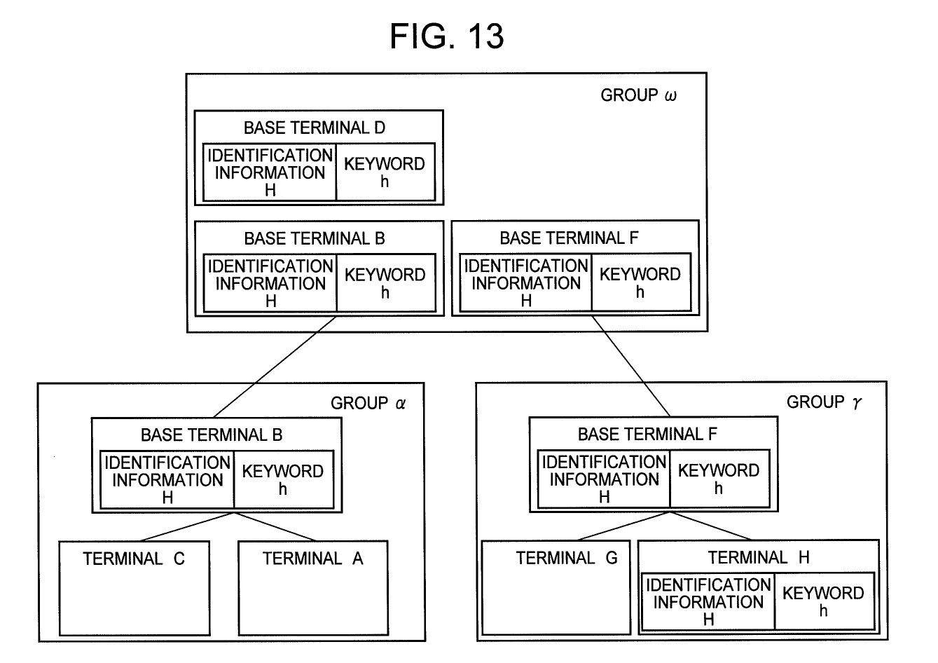

### DESCRIPTION OF THE EMBODIMENTS

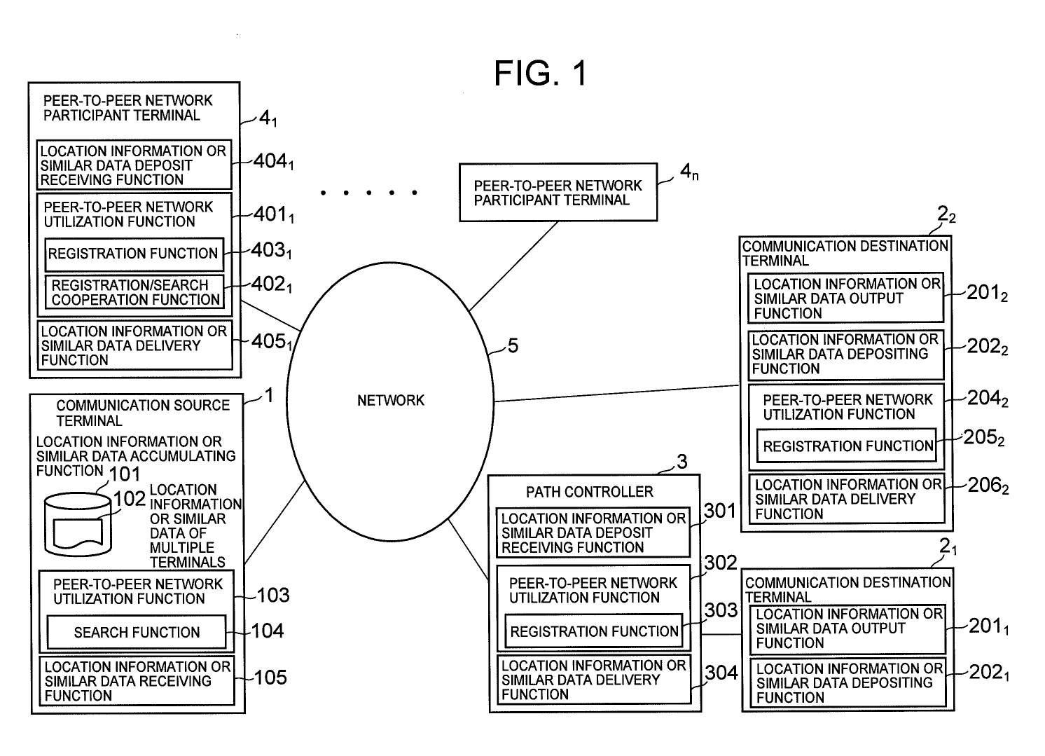

The outline of the present invention will be given. The present invention roughly has a configuration shown in FIG. 1.

This configuration includes terminals that utilize an arbitrary method of peer-to-peer network technology, such as the method using DHT or the “inter-group cooperation method”.

Of these terminals, one that initiates a communication session is a communication source terminal 1, and one that is accessed by the communication source terminal 1 for a communication session is a communication destination terminal 2 (in FIG. 1, terminals 2₁ and 2₂ serve as the communication source terminal 1 and the communication destination terminal 2, respectively). The rest of the terminals are peer-to-peer network participant terminals 4₁ to 4ₙ (hereinafter, collectively referred to as peer-to-peer network participant terminals 4). All of these terminals are coupled to a network 5.

The communication source terminal 1 has, as one of peer-to-peer network utilization functions 103 for utilizing peer-to-peer network technology, a search function 104 to find and receive location information or similar data 8, which is information necessary to communicate with the communication destination terminal 2. The communication source terminal 1 also has a location information or similar data receiving function 105 and a location information or similar data accumulating function 101. With the location information or similar data receiving function 105, location information received by the search function 104 is used to access a terminal that holds the location information or similar data 8 and to receive the location information or similar data 8. With the location information or similar data accumulating function 101, pieces of the location information or similar data 8 of multiple terminals are accumulated and held as a location information or similar data list 102.

The communication destination terminal 2 which is accessed by the communication source terminal 1 for a communication session can be, other than the communication destination terminal 2₂ which is coupled directly to the network 5, a communication destination terminal 2₁ which is coupled to the network 5 via a path controller 3 such as a proxy server, or a FW, or a NAT machine.

The communication destination terminal 2 has at least a function 201 for outputting (creating) its own location information and, if necessary, the above communication path information, the above secure communication parameters, and the above video-, audio-, or other communication parameters as the location information or similar data 8.

The path controller 3 has a location information or similar data deposit receiving function 301, a registration function 303, and a location information or similar data delivery function 304. With the location information or similar data deposit receiving function 301, the location information or similar data 8 is received from the communication destination terminal 2. The registration function 303 is used to register the location information or similar data 8 as one of peer-to-peer network utilization functions 302 for utilizing peer-to-peer network technology. The location information or similar data delivery function 304 is used to hand over the location information or similar data 8 to the communication source terminal 1. The communication destination terminal 2₁ therefore does not need to have in itself functions for utilizing peer-to-peer network technology.

The peer-to-peer network participant terminals 4 have a registration function 403 and a registration/search cooperation function 402 as basic functions of terminals that utilize peer-to-peer network technology. With the registration function 403, information is registered to a peer-to-peer network. The registration/search cooperation function 402 enables each peer-to-peer network participant terminal 4 to cooperate in meeting a registration or search request sent from another terminal.

The terminals described above cooperate with one another with the use of peer-to-peer network technology and form a peer-to-peer network over which information is registered or retrieved.

The communication source terminal 1 can conduct a search for the location information or similar data 8 of multiple terminals that are members of the community when the network traffic density is low, for example, late at night or other times of day when the flow of normal business operation data stops. In this case, the communication source terminal 1 can find the objective information through the search even if the communication destination terminal 2 is temporarily disconnected from the network, as long as the location information or similar data 8 of the communication destination terminal 2 is handed to the path controller 3 or to the peer-to-peer network participant terminals 4 and registered in the peer-to-peer network by the path controller 3 or by the terminals 4 in advance. The first problem in that a heavy load is applied to the network is thus solved.

The communication source terminal 1 has a function of accumulating the found location information or similar data 8 in addition to the function of searching for information with the use of peer-to-peer network technology. Accordingly, by treating the peer-to-peer network participant terminals 4 as the communication destination terminal 2 and searching for and accumulating the location information or similar data 8, the communication source terminal 1 can collect the location information or similar data 8 of multiple terminals that are members of the community. This enables the communication source terminal 1 to establish peer-to-peer communication with a terminal within the community using the accumulated information, and solves the second problem which is about the inefficiency of conducting negotiation each time a communication session with the same party is to be held.

When the above function is used in the presence of the path controller 3, the communication destination terminal 2₁ outputs and hands over the location information or similar data 8 to the path controller 3, the path controller 3 registers the location information or similar data 8 in the peer-to-peer network, and the communication source terminal 1 conducts a search with the functions for utilizing peer-to-peer network technology and obtains the location information or similar data 8 through peer-to-peer communication with the path controller 3. Using the obtained location information or similar data 8, the communication source terminal 1 accesses the communication destination terminal 2₁ and establishes peer-to-peer communication with the communication destination terminal 2₁. The third problem in that a path controller inhibits peer-to-peer communication is thus solved.

A more specific description will be given below through embodiments of the present invention.

Embodiments of the present invention discussed herein are a first embodiment and a second embodiment. The first embodiment takes as an example a case in which users of terminals located in different corporations form a cross-company group to communicate audio data, exchange documents, or the like through peer-to-peer communication held between members of the group over a network. The second embodiment takes as an example a case in which multiple households form a group to exchange video data, audio data, and the like created in the respective households through peer-to-peer communication held between members of the group.

These embodiments are not to limit the present invention. Also, specific methods of peer-to-peer network technology that are given as examples in the first and second embodiments are not intended to limit what method of peer-to-peer network technology can be used in the present invention.

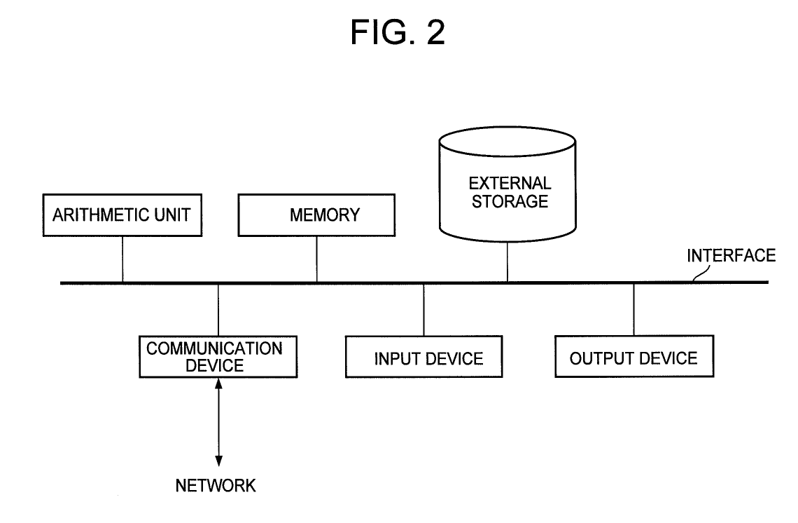

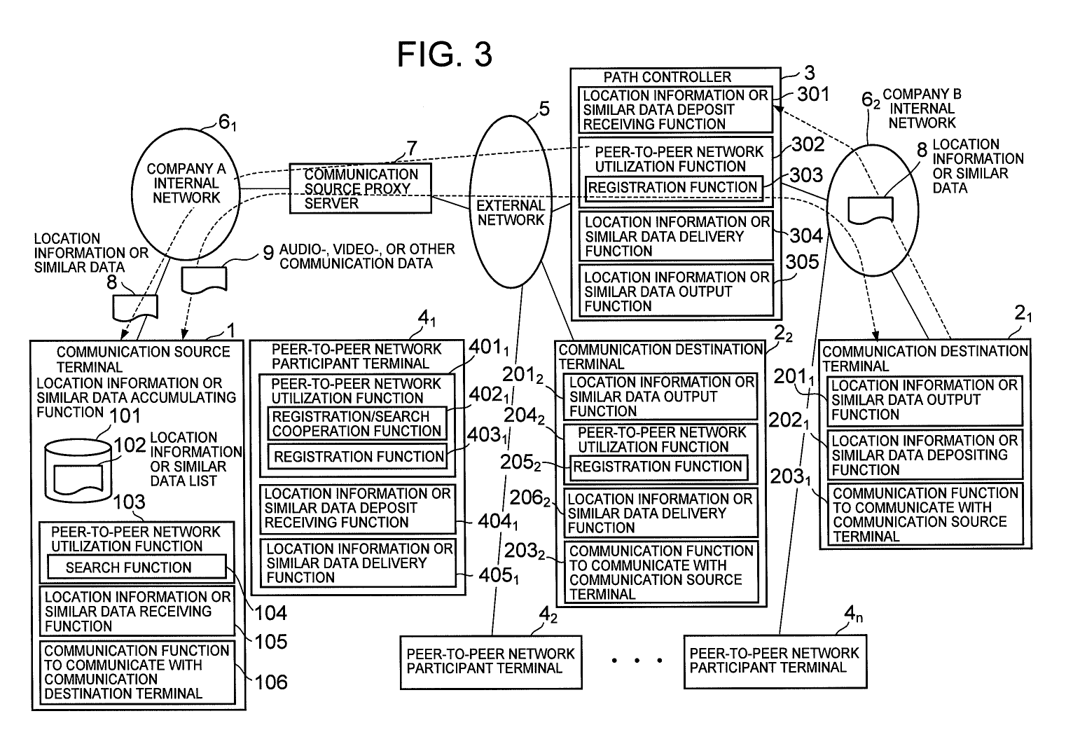

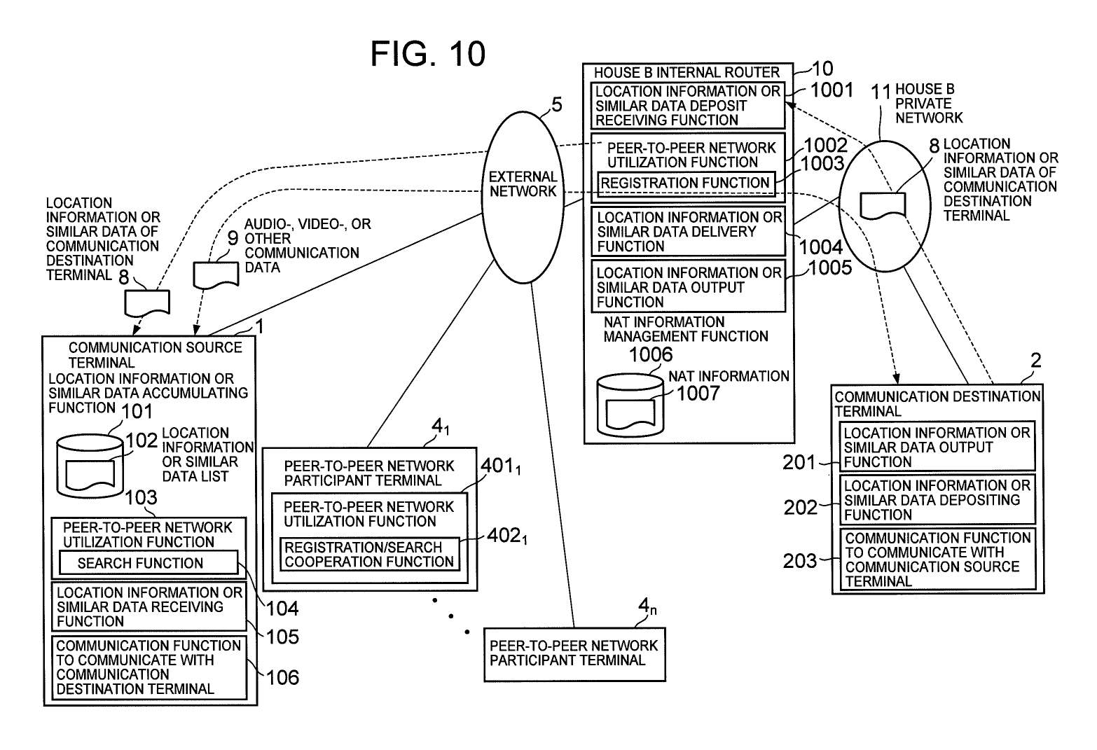

The communication source terminal 1, communication destination terminal 2, communication destination proxy server 3, peer-to-peer network participant terminals 4, communication source proxy server 7, and house B internal router 10 of the embodiments illustrated in FIGS. 3 and 10 are implemented by computers (including personal computers and home electronic appliances) each of which has, as shown in FIG. 2, an arithmetic unit (a central processing unit: CPU), a memory, external storage such as a hard disk, a communication device for communication with another device over a network, an input device such as a keyboard or buttons, an output device such as a monitor, and an interface for transmission and reception of data among these components. The components' respective functions are carried out when the CPU executes given programs which are loaded onto the memory.

### First Embodiment

FIG. 3 shows a configuration example of an embodiment of the present invention in which users of terminals located in different corporations form a cross-company group to communicate audio data, exchange documents, or the like through peer-to-peer communication held between members of the group over a network.

In this embodiment, the method using DHT is employed as peer-to-peer network technology.

The terminals operated by the group members can utilize the method using DHT. A terminal that is operated by a member a of the group is connected to a company A internal network 6₁. A terminal that is operated by a member b of the group is coupled to a company B internal network 6₂. A terminal that is operated by a member c of the group is coupled to an external network 5. Terminals operated by the rest of the members of the group are individually coupled to the external network 5, the company A internal network 6₁, the company B internal network 6₂, or an internal network of another company.

Terminals coupled to the company B internal network 6₂ communicate with the external network 5 via the path controller 3 such as a proxy server or a FW. The terminal that is operated by the member a is the communication source terminal 1. The terminal that is operated by the member b is the communication destination terminal 2₁. The terminal that is operated by the member c is the communication destination terminal 2₂. The terminals operated by the rest of the members are the peer-to-peer network participant terminals 4 (4₁˜4ₙ).

In the following description, “communication destination terminal 2” is used when the description applies to either one of the communication destination terminal 2₁ and the communication destination terminal 2₂.

In this embodiment, each communication destination terminal 2 registers the location information or similar data 8, which is information necessary to communicate with the communication source terminal 1, with the use of peer-to-peer network technology and the peer-to-peer network participant terminals 4. The communication source terminal 1 searches for the registered location information or similar data 8 through the peer-to-peer network participant terminals 4, accumulates the obtained location information or similar data 8 as the location information or similar data list 102, and accesses the communication destination terminal 2 using this information.

Note that any of the terminals operated by the group members can serve as the communication source terminal 1 or the communication destination terminal 2. The terminals operated by the group members can each create the location information or similar data list 102 and perform peer-to-peer communication with another terminal in the manner described above.

The premise of this embodiment is that, when a terminal that is coupled to other network than the company B internal network 6₂ accesses the communication destination terminal 2₁ coupled to the company B internal network 6₂, the outside terminal has to present the path controller 3 with a password, in addition to the IP address of the communication destination terminal 2, as information necessary to communicate with the communication destination terminal 2.

To establish peer-to-peer communication with the communication destination terminal 2, the communication source terminal 1 and the communication destination terminal 2 need to adjust secure communication parameters, which are information necessary to ensure the security (information such as a password used in authentication or communication path encryption, and a public key certificate) and video-, audio-, or other data communication parameters, which are necessary for exchange of documents, audio/video communications, or the like, in a manner that enables the terminals to exchange information with each other.

The communication source terminal 1 has, as one of the peer-to-peer network utilization functions 103 for utilizing peer-to-peer network technology, the search function 104 to search for the location information or similar data 8, which is information necessary to communicate with the communication destination terminal 2, and to receive as a search result the location information of a terminal that holds the location information or similar data 8. The communication source terminal 1 also has the location information or similar data receiving function 105, the location information or similar data accumulating function 101, and a communication function 106. With the location information or similar data receiving function 105, the location information received by the search function 104 is used to access the terminal that holds the location information or similar data 8 and to receive the location information or similar data 8. With the location information or similar data accumulating function 101, pieces of the location information or similar data 8 of multiple terminals are accumulated and held as the location information or similar data list 102. The communication function 106 uses the location information or similar data 8 to access the communication destination terminal 2 and to exchange audio-, video-, or other communication data 9 such as audio data or a document with the communication destination terminal 2.

The location information or similar data 8, which is information necessary to communicate with the communication destination terminal 2, specifically includes the IP address of the path controller 3, a password that grants passage through the path controller 3, identification information of the communication destination terminal 2 which is used in transfer of a communication from the path controller 3 to the communication destination terminal 2, various parameters necessary for audio communication or document exchange with the communication destination terminal 2, and the like.

The communication destination terminal 2₁ has a location information or similar data output function 201₁, which outputs the location information or similar data 8, a location information or similar data depositing function 202₁, with which the output data is handed over to the path controller 3, and a communication function 203₁, which accepts access from the communication source terminal 1 to exchange the audio-, video-, or other communication data 9 with the communication source terminal 1.

The path controller 3 has the location information or similar data deposit receiving function 301, the registration function 303, and the location information or similar data delivery function 304. With the location information or similar data deposit receiving function 301, the location information or similar data 8 is received from the communication destination terminal 2. The registration function 303 is used to register the location information or similar data 8 as one of the peer-to-peer network utilization functions 302 for utilizing peer-to-peer network technology. The location information or similar data delivery function 304 is used to hand over the location information or similar data 8 to the communication source terminal 1. Instead of receiving the location information or similar data 8 from the communication destination terminal 2, the path controller 3 may have a location information or similar data output function 305, which outputs the location information or similar data 8 of the communication destination terminal 2 in place of the communication destination terminal 2 upon request made by the communication destination terminal 2 with another function such as an offline submission function.

The communication destination terminal 2₂ has a location information or similar data output function 201₂, which outputs the location information or similar data 8, the communication function 203₂, which accepts access from the communication source terminal 1 to exchange the audio-, video-, or other communication data 9 with the communication source terminal 1, a registration function 205₂, which is used to register the location information or similar data 8 as one of peer-to-peer network utilization functions 204₂ for utilizing peer-to-peer network technology, and a location information or similar data delivery function 206₂, with which the location information or similar data 8 is handed over to the communication source terminal 1.

Each peer-to-peer network participant terminal 4 has the registration/search cooperation function 402, the registration function 403, a location information or similar data deposit receiving function 404, and a location information or similar data delivery function 405. The registration/search cooperation function 402 is, as one of peer-to-peer network utilization functions 401 for utilizing peer-to-peer network, used to transfer or register a registration request of a terminal in accordance with an algorithm of the method that uses DHT, and to transfer the registration request in accordance with an algorithm of the method that uses DHT or send the location information of the terminal that has issued the registration request to a terminal that has issued a search request. The registration function 403 is used to register the location information or similar data 8. With the location information or similar data deposit receiving function 404, the location information or similar data 8 is received from the communication destination terminal 2. With the location information or similar data delivery function 405, the location information or similar data 8 is handed over to the communication source terminal 1.

The characteristic operation of the network system of FIG. 3 will be described next. The operation of the network system differs from when the communication source terminal 1 obtains the location information or similar data 8 of the communication destination terminal 2₁ to accumulate the data in the location information or similar data list 102 to when the communication source terminal 1 obtains the location information or similar data 8 of the communication destination terminal 2₂ to accumulate the data in the location information or similar data list 102, and the two cases will be described separately.

Described first with reference to the drawings is a part of the operation of the network system when the communication source terminal 1 obtains the location information or similar data 8 of the communication destination terminal 2₁ to accumulate the data in the location information or similar data list 102. This part covers from the start to registration of the location information or similar data 8 of the communication destination terminal 2₁ with the use of peer-to-peer network technology.

This embodiment includes two cases, one being a case in which the communication destination terminal 2₁ outputs the location information or similar data 8 and the other being a case in which the path controller 3 outputs the location information or similar data 8 of the communication destination terminal 2₁. The case in which the communication destination terminal 2₁ outputs the location information or similar data 8 will be described first.

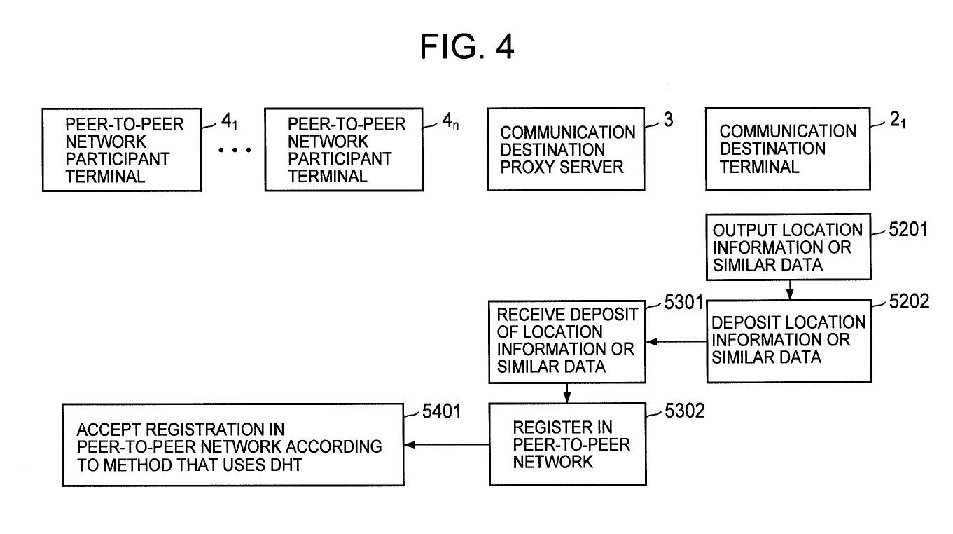

FIG. 4 shows the operation of the communication destination terminal 2₁, the path controller 3, and the peer-to-peer network participant terminals 4 when the communication destination terminal 2₁ outputs the location information or similar data 8 and registers the output location information or similar data 8 in the peer-to-peer network in the network system of FIG. 3.

First, the location information or similar data output function 201₁ in the communication destination terminal 2₁ outputs, as the location information or similar data 8 of the communication destination terminal 2₁, information necessary to access the communication destination terminal 2₁ from the external network 5 (the IP address of the communication destination terminal 2₁, the IP address of the path controller 3, and a password that is information used by the path controller 3 in transferring a communication from the external network 5 to the communication destination terminal 2₁), and secure communication parameters and video-, audio-, or other communication parameters which are used in communication with the communication destination terminal 2₁ (Step 5201).

Next, the location information or similar data depositing function 202₁ hands the location information or similar data 8 over to the path controller 3 (Step 5202).

In the path controller (communication destination proxy server) 3, the location information or similar data deposit receiving function 301 receives the location information or similar data 8 from the communication destination terminal 2₁ (Step 5301). The registration function 302 registers the location information or similar data 8 in the peer-to-peer network (Step 5302). In this step, since the method using DHT is employed as peer-to-peer network technology, a name that identifies the location information or similar data 8 is given as the nickname of the group member b and a hash value is calculated by a specific hash algorithm. The obtained hash value for the identification name of the location information or similar data 8 and the location information of the path controller 3 are handed to one of the peer-to-peer network participant terminals 4.

In the peer-to-peer network participant terminal 4, the registration/search cooperation function 402 registers the hash value for the identification name of the location information or similar data 8 of the communication destination terminal 2₁, along with the location information of the path controller 3, in the peer-to-peer network in accordance with the method that uses DHT (Step 5401).

Described above is the operation of the network system when the communication destination terminal 2₁ outputs the location information or similar data 8 and registers the output location information or similar data 8 in the peer-to-peer network.

The description given next is about the case where it is the path controller 3 that outputs the location information or similar data 8 of the communication destination terminal 2₁.

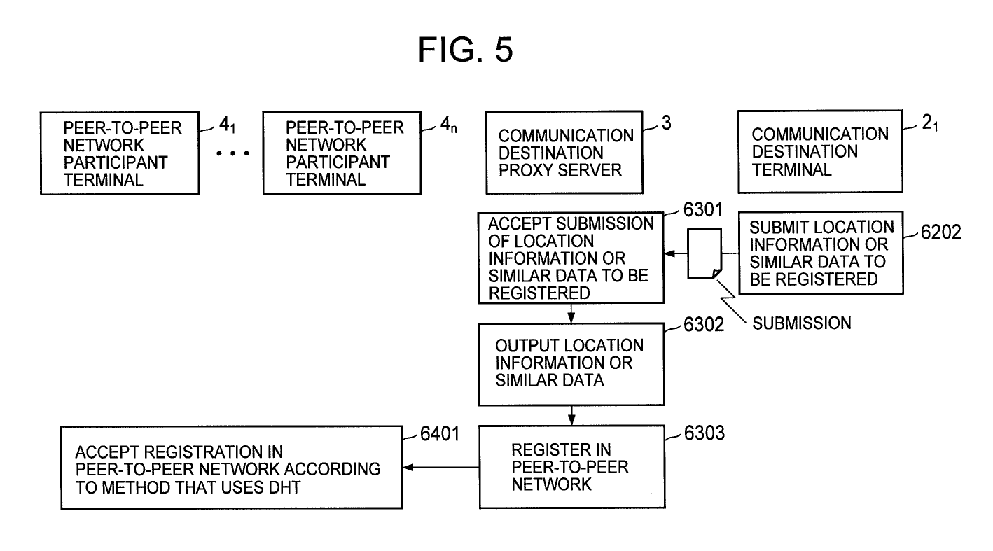

FIG. 5 shows the operation of the communication destination terminal 2, the path controller 3, and the peer-to-peer network participant terminals 4 when the path controller 3 outputs the location information or similar data 8 of the communication destination terminal 2₁ and registers the output location information or similar data 8 in the peer-to-peer network in the network system of FIG. 3.

First, the operator of the communication destination terminal 2₁ and the operator of the path controller 3 make an offline agreement so that the path controller 3 outputs the location information or similar data 8 of the communication destination terminal 2₁ in place of the communication destination terminal 2₁ (Steps 6202 and 6301). When the agreement is made, the operator of the path controller 3 is given the nickname of the communication destination terminal 2₁ which is unique throughout the group and information on a hash algorithm used in Step 6303, which is described below.

In the path controller 3, the location information or similar data output function 305 outputs, as the location information or similar data 8 of the communication destination terminal 2₁, information necessary to access the communication destination terminal 2₁ from the external network 5 (the IP address of the communication destination terminal 2₁, the IP address of the path controller 3, and a password or other information used by the path controller 3 in transferring a communication from the external network 5 to the communication destination terminal 2₁), and secure communication parameters and video-, audio-, or other communication parameters which are used in communication with the communication destination terminal 2₁ (Step 6302).

Next, the registration function 303 registers the location information or similar data 8 in the peer-to-peer network (Step 6303). In this step, since the method using DHT is employed as peer-to-peer network technology, a name that identifies the location information or similar data 8 is given as the nickname of the group member b and a hash value is calculated by a specific hash algorithm. The obtained hash value for the identification name of the location information or similar data 8 and the location information of the path controller 3 are handed to one of the peer-to-peer network participant terminals 4.

In the peer-to-peer network participant terminal 4, the registration/search cooperation function 402 registers the hash value for the identification name of the location information or similar data 8 of the communication destination terminal 2₁, along with the location information of the path controller 3, in the peer-to-peer network in accordance with the method that uses DHT (Step 6401).

Described above is the operation of the network system when the path controller 3 outputs the location information or similar data 8 of the communication destination terminal 2₁ and registers the output location information or similar data 8 in the peer-to-peer network.

The description given next with reference to the drawings is about a part of the operation of the network system of FIG. 3 which covers the acquisition of the location information or similar data 8 of the communication destination terminal 2₁ by the communication source terminal 1 after the location information or similar data 8 is registered.

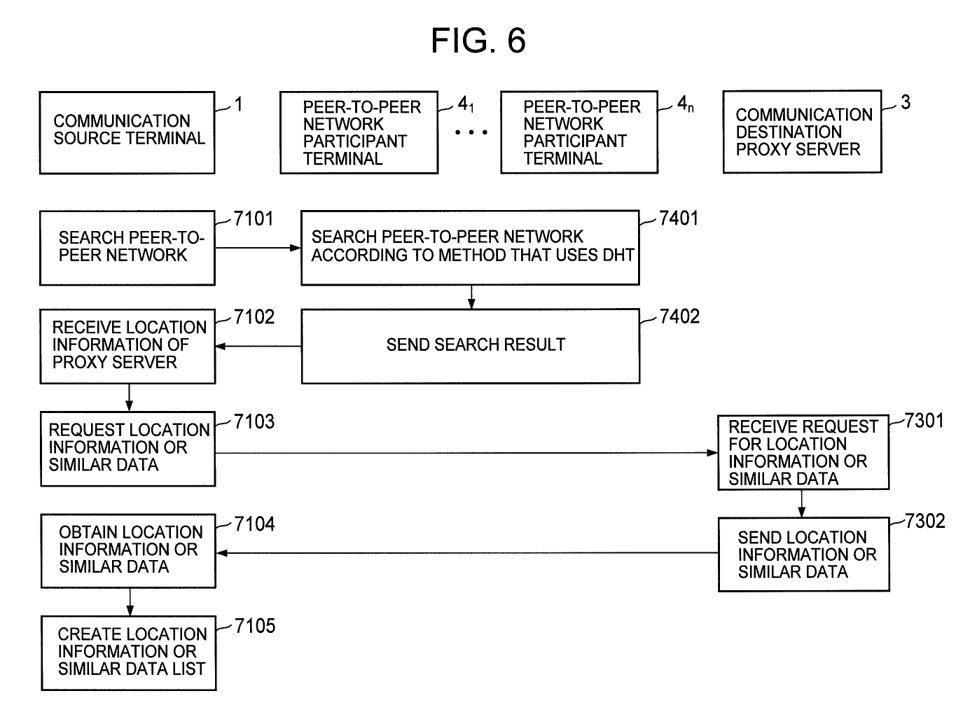

FIG. 6 shows the operation of the communication source terminal 1, the communication destination terminal 2₁, the path controller 3, and the peer-to-peer network participant terminals 4 when the communication source terminal 1 obtains the location information or similar data 8 of the communication destination terminal 2₁ in the network system of FIG. 3.

Prior to initiating a communication session with the communication destination terminal 2₁, the communication source terminal 1 knows a nickname unique within the group to the member b who operates the communication destination terminal 2₁. The search function 104 searches the peer-to-peer network using the nickname of the member b who operates the communication destination terminal 2₁ (Step 7101). In this step, a specific hash algorithm is used to calculate the hash value of the nickname given to the member b who operates the communication destination terminal 2₁. The terminals of the same group agree in advance to employ the same hash algorithm, and the hash algorithm used in Step 7101 is the same as the one used in the above-described Steps 5302 and 6303. The hash value obtained in Step 5302 and Step 6303 is therefore equal to the hash value obtained in Step 7101.

The search/registration cooperation function 402 in the peer-to-peer network participant terminal 4 uses the hash value of the nickname given to the member b who operates the communication destination terminal 2₁ to find, in accordance with the method that uses DHT, the path controller 3 as a terminal in which this hash value is registered (Step 7401). The result of the search is sent to the communication source terminal 1 (Step 7402).

In the communication source terminal 1, the search function 104 obtains the location information of the path controller 3 from the peer-to-peer network participant terminal 4 (Step 7102).

Next, the location information or similar data receiving function 105 requests the location information or similar data 8 of the communication destination terminal 2₁ from the path controller 3 (Step 7103).

The location information or similar data delivery function 304 in the path controller 3 receives the request from the communication source terminal 1 (Step 7301), and sends the location information or similar data 8 of the communication destination terminal 2₁ to the communication source terminal 1 (Step 7302). In this step, the path controller 3 may judge whether to hand over the location information or similar data 8 to the communication source terminal 1 by performing authentication on the communication source terminal 1. Examples of authentication methods that can be employed in this step include the use of information confidential to the members of the group and the use of a public key certificate which is the proof of the group membership. The present invention does not put limitation on what authentication method is employable.

In the communication source terminal 1, the location information or similar data receiving function 105 receives the location information or similar data 8 of the communication destination terminal 2₁ from the path controller 3 (Step 7104). The location information or similar data accumulating function 101 adds the just found location information or similar data 8 of the communication destination terminal 2₁ to the location information or similar data list 102, where pieces of the location information or similar data 8 of the terminals within the group are consolidated (Step 7105).

Described above is the operation of the network system when the communication source terminal 1 obtains the location information or similar data 8 of the communication destination terminal 2₁ and accumulates the data in the location information or similar data list 102.

The description given next is about the operation of the network system when the communication source terminal 1 obtains the location information or similar data 8 of the communication destination terminal 2₂ and accumulates the data in the location information or similar data list 102.

Described first with reference to the drawings is the operation of registering the location information or similar data 8 of the communication destination terminal 2₂ with the use of peer-to-peer network technology.

This embodiment includes two cases, one being a case in which the communication destination terminal 2₂ registers the location information or similar data 8 in the peer-to-peer network, and the other being a case in which the communication destination terminal 2₂ commissions one or more of the peer-to-peer network participant terminals 4 to register the location information or similar data 8 of the communication destination terminal 2₂ sin the peer-to-peer network. The case in which the communication destination terminal 2₂ registers the location information or similar data 8 in the peer-to-peer network will be described first.

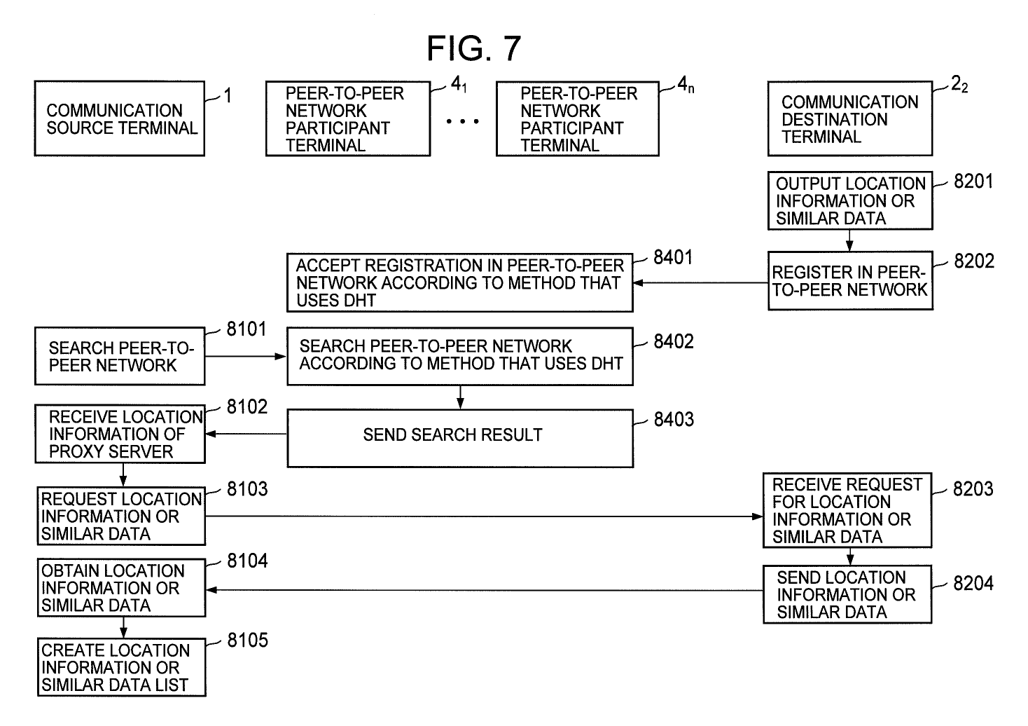

FIG. 7 shows the operation of the communication source terminal 1, the communication destination terminal 2₂, and the peer-to-peer network participant terminals 4 when the communication destination terminal 2₂ outputs the location information or similar data 8, registers the output location information or similar data 8 in the peer-to-peer network, and the communication source terminal 1 obtains the information in the network system of FIG. 3.

The location information or similar data output function 201₂ in the communication destination terminal 2₂ outputs, as the location information or similar data 8 of the communication destination terminal 2₂, information necessary to access the communication destination terminal 2₂ (the IP address of the communication destination terminal 2₂), and secure communication parameters and video-, audio-, or other communication parameters which are used in communication with the communication destination terminal 2₂ (Step 8201).

The registration function 205₂ in the communication destination terminal 2₂ registers the location information or similar data 8 in the peer-to-peer network (Step 8202). In this step, since the method using DHT is employed as peer-to-peer network technology, a name that identifies the location information or similar data 8 is given as the nickname of the group member c and a hash value is calculated by a specific hash algorithm. The obtained hash value for the identification name of the location information or similar data and the location information of the communication destination terminal 2₂ are handed to one of the peer-to-peer network participant terminals 4.

In the peer-to-peer network participant terminal 4, the registration/search cooperation function 401 registers the hash value for the identification name of the location information or similar data 8 of the communication destination terminal 2₂, along with the location information of the communication destination terminal 2₂, in the peer-to-peer network in accordance with the method that uses DHT (Step 8401).

Prior to initiating a communication session with the communication destination terminal 2₂, the communication source terminal 1 knows the nickname unique within the group to the member c who operates the communication destination terminal 2₂.

The search function 104 in the communication source terminal 1 searches the peer-to-peer network using the nickname of the member c who operates the communication destination terminal 2₂ (Step 8101). In this step, a specific hash algorithm is used to calculate the hash value of the nickname given to the member c who operates the communication destination terminal 2₂. The terminals of the same group agree in advance to employ the same hash algorithm, and the hash algorithm used in Step 8101 is the same as the one used in the above-described Step 8202. The hash value obtained in Step 8202 is therefore equal to the hash value obtained in Step 8101.

The search/registration cooperation function 402 in the peer-to-peer network participant terminal 4 uses the hash value of the nickname given to the member c who operates the communication destination terminal 2₂ to find, in accordance with the method that uses DHT, the communication destination terminal 2₂ as a terminal in which this hash value is registered (Step 8402). The result of the search is sent to the communication source terminal 1 (Step 8403).

In the communication source terminal 1, the search function 104 obtains the location information of the communication destination terminal 2₂ from the peer-to-peer network participant terminal 4 (Step 8102).

Next, the location information or similar data receiving function 105 requests the location information or similar data 8 of the communication destination terminal 2₂ from the communication destination terminal 2₂ (Step 8103).

The location information or similar data delivery function 206₂ in the communication destination terminal 2₂ receives the request from the communication source terminal 1 (Step 8203), and sends the location information or similar data 8 of the communication destination terminal 2₂ to the communication source terminal 1 (Step 8204). In this step, the communication destination terminal 2₂ may judge whether to hand over the location information or similar data 8 to the communication source terminal 1 by performing authentication on the communication source terminal 1. Examples of authentication methods that can be employed in this step include the use of information confidential to the members of the group and the use of a public key certificate which is the proof of the group membership. The present invention does not put limitation on what authentication method is employable.

In the communication source terminal 1, the location information or similar data receiving function 105 receives the location information or similar data 8 of the communication destination terminal 2₂ from the communication destination terminal 2₂ (Step 8104). The location information or similar data accumulating function 101 adds the just found location information or similar data 8 of the communication destination terminal 2₂ to the location information or similar data list 102, where pieces of the location information or similar data 8 of the terminals within the group are consolidated (Step 8105).

Described above is the operation of the network system when the communication destination terminal 2₂ outputs the location information or similar data 8 and registers the output location information or similar data 8 in the peer-to-peer network, and the communication source terminal 1 obtains the registered information to accumulate the information in the location information or similar data list 102.

The description given next is about the case in which the communication destination terminal 2₂ commissions one or more of the peer-to-peer network participant terminals 4 to register the location information or similar data 8 in the peer-to-peer network of the communication destination terminal 2₂ in the peer-to-peer network. In this embodiment, the communication destination terminal 2₂ commissions the peer-to-peer network participant terminal 4₂, but may commission two or more of the peer-to-peer network participant terminals 4.

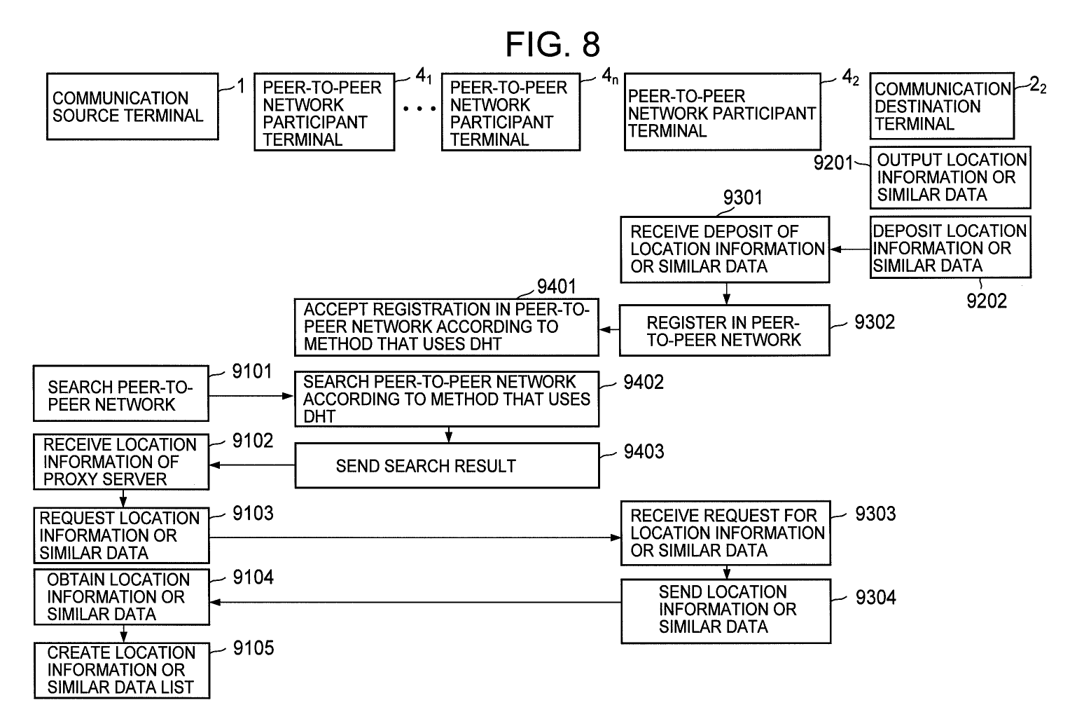

FIG. 8 shows the operation of the communication source terminal 1, the communication destination terminal 2₂, and the peer-to-peer network participant terminals 4 when the communication destination terminal 2₂ outputs the location information or similar data 8, the peer-to-peer network participant terminal 4₂ registers the output location information or similar data 8 in the peer-to-peer network, and the communication source terminal 1 obtains the registered information in the network system of FIG. 3.

In the communication destination terminal 2₂, the location information or similar data output function 201₂ outputs, as the location information or similar data 8 of the communication destination terminal 2₂, the IP address of the communication destination terminal 2₂ which is information necessary to access the communication destination terminal 2₂ and secure communication parameters and video-, audio-, or other communication parameters which are used in communication with the communication destination terminal 2₂ (Step 9201). Next, the location information or similar data depositing function 202₁ hands over the location information or similar data 8 to the peer-to-peer network participant terminal 4₂ (Step 9202).

In the peer-to-peer network participant terminal 4₂, the location information or similar data deposit receiving function 4042 receives the location information or similar data 8 from the communication destination terminal 2₁ (Step 9301). The registration function 4032 registers the location information or similar data 8 in the peer-to-peer network (Step 9302). In this step, since the method using DHT is employed as peer-to-peer network technology, a name that identifies the location information or similar data 8 is given as the nickname of the group member c and a hash value is calculated by a specific hash algorithm. The obtained hash value for the identification name of the location information or similar data 8 and the location information of the path controller 3 are handed to one of the peer-to-peer network participant terminals 4.

In the peer-to-peer network participant terminal 4, the registration/search cooperation function 402 registers the hash value for the identification name of the location information or similar data 8 of the communication destination terminal 2₂, along with the location information of the path controller 3, in the peer-to-peer network in accordance with the method that uses DHT (Step 9401).

At this point, prior to initiating a communication session with the communication destination terminal 2₂, the communication source terminal 1 knows a nickname unique within the group to the member c who operates the communication destination terminal 2₂. The search function 104 searches the peer-to-peer network using the nickname of the member c who operates the communication destination terminal 2₂ (Step 9101). In this step, a specific hash algorithm is used to calculate the hash value of the nickname given to the member c who operates the communication destination terminal 2₂. The terminals of the same group agree in advance to employ the same hash algorithm, and the hash algorithm used in Step 9101 is the same as the one used in the above-described Step 9302. The hash value obtained in Step 9302 is therefore equal to the hash value obtained in Step 9101.

The search/registration cooperation function 402 in the peer-to-peer network participant terminal 4 uses the hash value of the nickname given to the member b who operates the communication destination terminal 2₂ to find, in accordance with the method that uses DHT, the peer-to-peer network participant terminal 4₂ as a terminal in which this hash value is registered (Step 9402). The result of the search is sent to the communication source terminal 1 (Step 9403).

In the communication source terminal 1, the search function 104 obtains the location information of the peer-to-peer network participant terminal 4₂ from the peer-to-peer network participant terminal 4 (Step 9102).

Next, the location information or similar data receiving function 105 requests the location information or similar data 8 of the communication destination terminal 2₂ from the peer-to-peer network participant terminal 4₂ (Step 9103).

The location information or similar data delivery function 4052 in the peer-to-peer network participant terminal 4₂ receives the request from the communication source terminal 1 (Step 9303), and sends the location information or similar data 8 of the communication destination terminal 2₂ to the communication source terminal 1 (Step 9304). In this step, the peer-to-peer network participant terminal 4₂ may judge whether to hand over the location information or similar data 8 to the communication source terminal 1 by performing authentication on the communication source terminal 1. Examples of authentication methods that can be employed in this step include the use of information confidential to the members of the group and the use of a public key certificate which is the proof of the group membership. The present invention does not put limitation on what authentication method is employable.

In the communication source terminal 1, the location information or similar data receiving function 105 receives the location information or similar data 8 of the communication destination terminal 2₁ from the peer-to-peer network participant terminal 4₂ (Step 9104). The location information or similar data accumulating function 101 adds the just found location information or similar data 8 of the communication destination terminal 2₂ to the location information or similar data list 102, where pieces of the location information or similar data 8 of the terminals within the group are consolidated (Step 9105).

Described above is the operation of the network system when the communication destination terminal 2₂ commissions one or more of the peer-to-peer network participant terminals 4 to register the location information or similar data 8 of the communication destination terminal 2₂ in the peer-to-peer network and the communication source terminal 1 obtains the registered information to accumulate the information in the location information or similar data list 102.

In the operation described above, by commissioning the path controller 3 or the peer-to-peer network participant terminal 4₂ to register the location information or similar data 8, the communication destination terminal 2 enables the communication source terminal 1 to obtain the location information or similar data 8 without communicating directly with the communication destination terminal 2₂. The communication source terminal 1 can thus obtain the location information or similar data 8 from the path controller 3 or the peer-to-peer network participant terminal 4₂ in which the location information or similar data 8 is deposited even when path control by the path controller 3 or the like inhibits direct communication with the communication destination terminal 2 or when the communication destination terminal 2 is not available for communication because a user of the communication destination terminal 2 has powered the communication destination terminal 2 off before going home.

Also, since the communication source terminal 1 can obtain the location information or similar data 8 without communicating directly with the communication destination terminal 2, a search for the location information or similar data 8 can be conducted late at night or other time of day when the network traffic density is low but the communication destination terminal 2 might be unavailable for communication.

The communication source terminal 1 can also create the location information or similar data list 102. In the case where the nicknames of members of a group are common knowledge within the group, any two peer-to-peer network participant terminals 4

may act as the communication source terminal 1 and the communication destination terminal 2, respectively, to individually accumulate information necessary to access terminals in the group. Each terminal in the group can thus access another member terminal for inter-terminal communication by referring to its own location information or similar data list 102, and the efficiency of communication between terminals is improved.

The description given next with reference to the drawings is about how the network system of FIG. 3 operates when the communication source terminal 1 accesses the communication destination terminal 2 using the location information or similar data list 102 to exchange the audio-, video-, or other communication data 9 with the communication destination terminal 2.

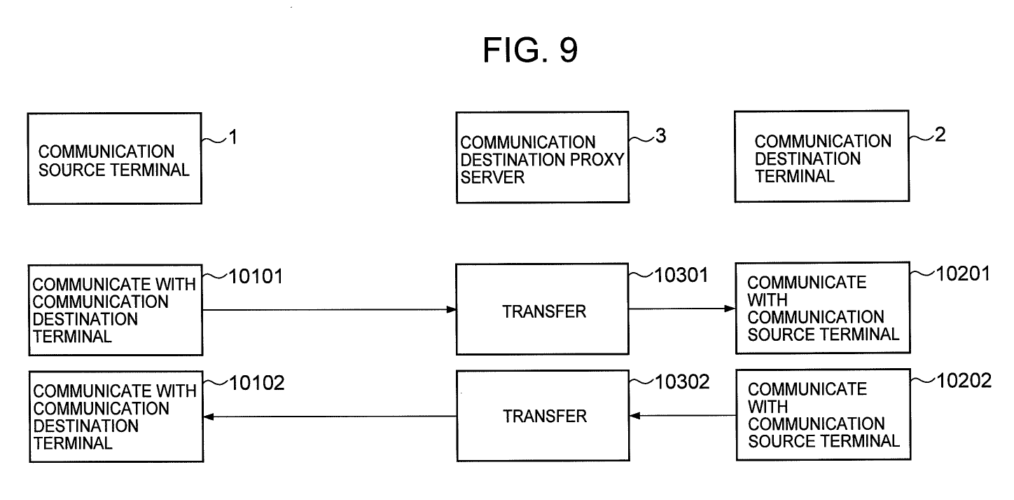

FIG. 9 shows the operation of the communication source terminal 1, the communication destination terminal 2, and the path controller 3 when the communication source terminal 1 accesses the communication destination terminal 2 using the location information or similar data list 102 to exchange the audio-, video-, or other communication data 9 with the communication destination terminal 2 in the network system of FIG. 3.

The communication function 106 in the communication source terminal 1 accesses the communication destination terminal 2 using the location information or similar data 8 of the communication destination terminal 2 which is written in the location information or similar data list 102 (Step 10101). In this step, a password that grants access to the communication destination terminal 2 and identification information for transfer to the communication destination terminal 2 are presented to the path controller 3. The path controller 3 uses the presented information to forward the communication to the communication destination terminal 2 (Step 10301). Thus granted access to the communication destination terminal 2, the communication source terminal 1 communicates for audio communication, document exchange, or the like with the communication destination terminal 2 in accordance with various parameters necessary for audio or other communication that are written in the location information or similar data 8 (Steps 10201, 10102, 10302, 10202).

Described above is the operation of the network system when the communication source terminal 1 accesses the communication destination terminal 2 using the location information or similar data list 102 to exchange the audio-, video-, or other communication data 9 with the communication destination terminal 2.

### Second Embodiment

FIG. 10 shows a configuration example of an embodiment of the present invention in which multiple households form a group to exchange video data, audio data, and the like created in the respective households through peer-to-peer communication held between members of the group with the use of a DVD player, a PC, or other picture reproducing machine that is coupled to a network.

This embodiment employs the “inter-group cooperation method” as peer-to-peer network technology.

The configuration of FIG. 10 has multiple picture reproducing machines that can utilize the “inter-group cooperation method” and reproduces images and sounds. The picture reproducing machines are coupled to the external network 5.

A picture reproducing machine that is operated by a user a is the communication source terminal 1 and a picture reproducing machine that is operated by a user b is the communication destination terminal 2. The rest of the picture reproducing machines are the peer-to-peer network participant terminals 4.

The communication destination terminal (picture reproducing machine) 2 operated by the user b is coupled to a house B private network 11, and is coupled to the external network 5 through NAT performed via the house B internal router 10. The communication source terminal (picture reproducing machine) 1 operated by the user a is coupled to the external network 5 without NAT. The rest of the terminals, namely, the peer-to-peer network participant terminals (picture reproducing machines) 4, are individually coupled to the external network 5 or a private network of another household.

In this embodiment, the communication destination terminal 2 registers the location information or similar data 8, which is information necessary to communicate with the communication destination terminal 2, using peer-to-peer network technology and the peer-to-peer network participant terminals 4. The registered location information or similar data 8 is obtained by the communication source terminal 1 with the use of the peer-to-peer network participant terminals 4. The communication source terminal 1 accumulates the obtained location information or similar data 8 as the location information or similar data list 102, and uses the accumulated information in accessing the communication destination terminal 2.

Note that any of the picture reproducing machines can serve as the communication source terminal 1 or the communication destination terminal 2. The picture reproducing machines can each create the location information or similar data list 102 and access the communication destination terminal 2 in the manner described above.

NAT is performed in the house B internal router 10. In NAT, a router or other machine that is coupled to both an external network and a private network holds NAT conversion information. The NAT conversion information associates an IP address and a port number that are allocated uniquely throughout the private network to a terminal coupled to the private network with an IP address and a port number that are unique throughout the external network. When a terminal coupled to the external network accesses a terminal coupled to the private network, an address and a port in the external network that are associated with the terminal to be accessed are presented to the router and the router can thus forward the communication to the terminal to be accessed based on the NAT conversion information.

The communication source terminal 1 therefore needs to present at least an IP address and a port in the external network 5 that are linked to the communication destination terminal 2 by the house B internal router 10 (hereinafter referred to as NAT information about the communication destination terminal 2) in accessing the communication destination terminal 2.

To establish peer-to-peer communication with the communication destination terminal 2, the communication source terminal 1 needs to adjust information necessary to ensure the security (information such as a password used in authentication or communication path encryption, and a public key certificate) and parameters necessary for video-, audio-, or other communication to suit a method presented by the communication destination terminal 2 before accessing the communication destination terminal 2.

The communication source terminal 1 has, as one of the peer-to-peer network utilization functions 103 for utilizing peer-to-peer network technology, the search function 104 to search for the location information or similar data 8, which is information necessary to communicate with the communication destination terminal 2, and to receive as a search result the location information of a terminal that holds the location information or similar data 8. The communication source terminal 1 also has the location information or similar data receiving function 105, the location information or similar data accumulating function 101, and the communication function 106. With the location information or similar data receiving function 105, the location information received by the search function 104 is used to access the terminal that holds the location information or similar data 8 and to receive the location information or similar data 8. With the location information or similar data accumulating function 101, pieces of the location information or similar data 8 of multiple terminals are accumulated and held as the location information or similar data list 102. The communication function 106 uses the location information or similar data 8 to access the communication destination terminal 2 and to exchange the audio-, video-, or other communication data 9 such as images or sounds with the communication destination terminal 2. The location information or similar data 8, which is information necessary to communicate with the communication destination terminal 2, specifically includes the IP address of the house B internal router 10, the NAT information about the communication destination terminal 2 which is used in transfer of a communication from the house B to the communication destination terminal 2, various parameters necessary for audio or video communication with the communication destination terminal 2, and the like.

The communication destination terminal 2 has the location information or similar data output function 201, which outputs the location information or similar data 8, the location information or similar data depositing function 202, with which the output data is handed over to the house B internal router 10, and the communication function 203, which accepts access from the communication source terminal 1 to exchange the audio-, video-, or other communication data 9 with the communication source terminal 1.

The house B internal router 10 has a location information or similar data deposit receiving function 1001, a registration function 1003, a location information or similar data delivery function 1004, and a NAT information management function 1006. With the location information or similar data deposit receiving function 1001, the location information or similar data 8 is received from the communication destination terminal 2. The registration function 1003 is used to register the location information or similar data 8 as one of peer-to-peer network utilization functions 1002 for utilizing peer-to-peer network technology. The location information or similar data delivery function 1004 is used to hand over the location information or similar data 8 to the communication source terminal 1. The NAT information management function 1006 is used to manage NAT information 1007.

Each peer-to-peer network participant terminal 4 has the registration/search cooperation function 402 which is, as one of the peer-to-peer network utilization functions 401 for utilizing peer-to-peer network technology, used to transfer or register a registration request of a terminal in accordance with an algorithm of the “inter-group cooperation method”, and to transfer the registration request in accordance with an algorithm of the “inter-group cooperation method” or send the location information of the terminal that has issued the registration request to a terminal that has issued a search request.

Described next with reference to the drawings is the operation of the network system of FIG. 10 when the communication source terminal 1 obtains the location information or similar data 8 of the communication destination terminal 2 and accumulates the obtained data in the location information or similar data list 102.

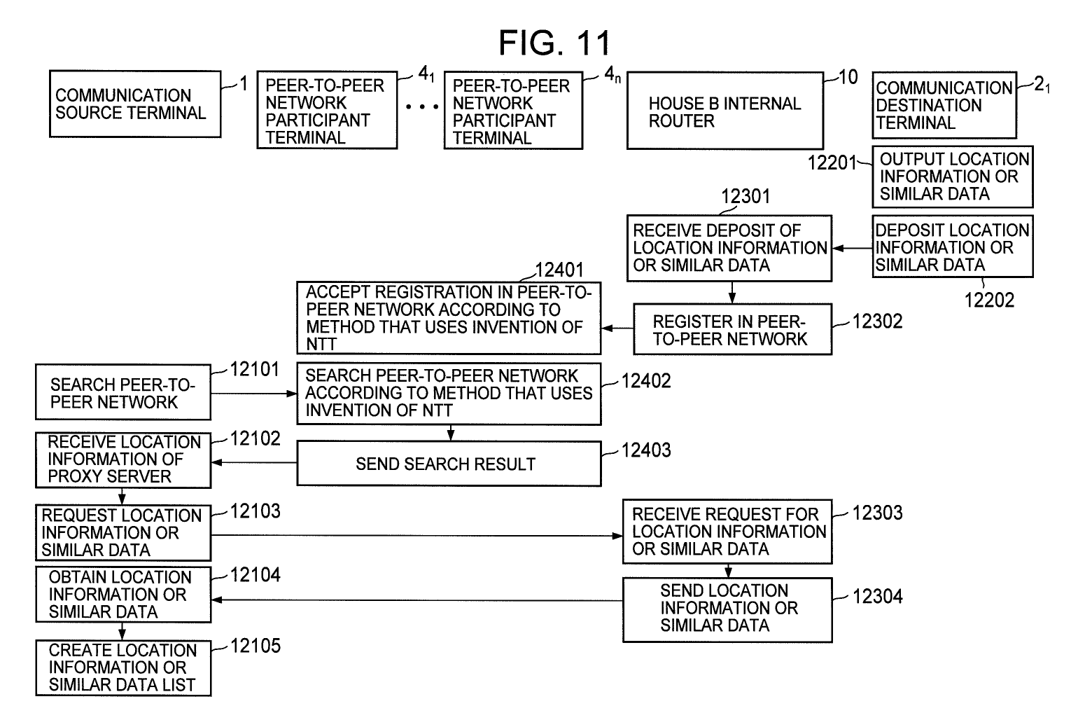

FIG. 11 shows the operation of the communication source terminal 1, the communication destination terminal 2, the house B internal router (proxy server) 10, and the peer-to-peer network participant terminals 4 when the communication source terminal 1 obtains the location information or similar data 8 of the communication destination terminal 2 and accumulates the obtained data in the location information or similar data list 102 in the network system of FIG. 10.

In the communication destination terminal 2, the location information or similar data output function 201 outputs, as the location information or similar data 8 of the communication destination terminal 2, information necessary to access the communication destination terminal 2 from the external terminal 5 (the IP address of the house B internal router 10 and the NAT information about the communication destination terminal 2), and secure communication parameters and video-, audio-, or other communication parameters which are used in communication with the communication destination terminal 2 (Step 12201). Next, the location information or similar data depositing function 202 hands over the location information or similar data 8 to the house B internal router 10 (Step 12202).

In the house B internal router 10, the location information or similar data deposit receiving function 1001 receives the location information or similar data 8 from the communication destination terminal 2 (Step 12301). The registration function 1003 registers the received location information or similar data 8 in the peer-to-peer network (Step 12302). In this step, since the “inter-group cooperation method” is employed as peer-to-peer network technology, the nickname of the user b which serves as identification information and a name that is given to a community the user a and the user b want to form and serves as a keyword are handed to one of the peer-to-peer network participant terminals 4 along with location information. The name of the community the user a and the user b want to form is known to both the user a and the user b through prior arrangements.

The registration/search cooperation function 401 in the peer-to-peer network participant terminal 4 registers the received information in the peer-to-peer network in accordance with the “inter-group cooperation method” (Step 12401).

The communication source terminal 1 knows the name of the community the user a and the user b want to form prior to initiating a communication session with the communication destination terminal 2. The search function 104 searches the peer-to-peer network with the name of the community the user a and the user b want to form as a keyword (Step 12101).

The registration/search cooperation function 401 in the peer-to-peer network participant terminal 4 finds the house B internal router 10 based on the keyword in accordance with the “inter-group cooperation method” (Step 12402). The result of the search is sent to the communication source terminal 1 (Step 12403).

In the communication source terminal 1, the search function 104 obtains the location information of the house B internal router 10 from the peer-to-peer network participant terminal 4 (Step 12102). Next, the location information or similar data receiving function 105 requests the location information or similar data 8 of the communication destination terminal 2 from the house B internal router 10 (Step 12103).

The location information or similar data delivery function 1004 in the house B internal router 10 receives the request from the communication source terminal 1 (Step 12303), and sends the location information or similar data 8 of the communication destination terminal 2 to the communication source terminal 1 (Step 12304). In this step, the house B internal router 10 may judge whether to hand over the location information or similar data 8 to the communication source terminal 1 by performing authentication on the communication source terminal 1. Examples of authentication methods that can be employed in this step include the use of information confidential between the user a and the user b and the use of a public key certificate which is the proof of the group membership. The present invention does not put limitation on what authentication method is employable.

In the communication source terminal 1, the location information or similar data receiving function 105 receives the location information or similar data 8 of the communication destination terminal 2 from the house B internal router 10 (Step 12104). The location information or similar data accumulating function 101 adds the just found location information or similar data 8 of the communication destination terminal 2₁ to the location information or similar data list 102, where pieces of the location information or similar data 8 of the terminals within the group are consolidated (Step 12105).

Described above is the operation of the network system when the communication source terminal 1 obtains the location information or similar data 8 of the communication destination terminal 2₁ and accumulates the data in the location information or similar data list 102.

In the operation described above, by commissioning the house B internal router 10 to register the location information or similar data 8, the communication destination terminal 2 enables the communication source terminal 1 to obtain the location information or similar data 8 without communicating directly with the communication destination terminal 2. The communication source terminal 1 can thus obtain the location information or similar data 8 from the house B internal router 10 or other machine in which the location information or similar data 8 is deposited even when path control by the house B internal router 10 or the like prohibits direct communication with the communication destination terminal 2.

Also, the communication source terminal 1 can create the location information or similar data list 102. In the case where other users than the user a and the user b are to join the community, any two terminals that are operated by other users than the user a and the user b may act as the communication source terminal 1 and the communication destination terminal 2, respectively, to individually accumulate information necessary to access terminals in the community. Each terminal in the community can thus access another member terminal for inter-terminal communication by referring to its own location information or similar data list 102, and the efficiency of communication between terminals is improved.

The description given next with reference to the drawings is about how the network system of FIG. 10 operates when the communication source terminal 1 accesses the communication destination terminal 2 using the location information or similar data list 102 to exchange the audio-, video-, or other communication data 9 with the communication destination terminal 2.

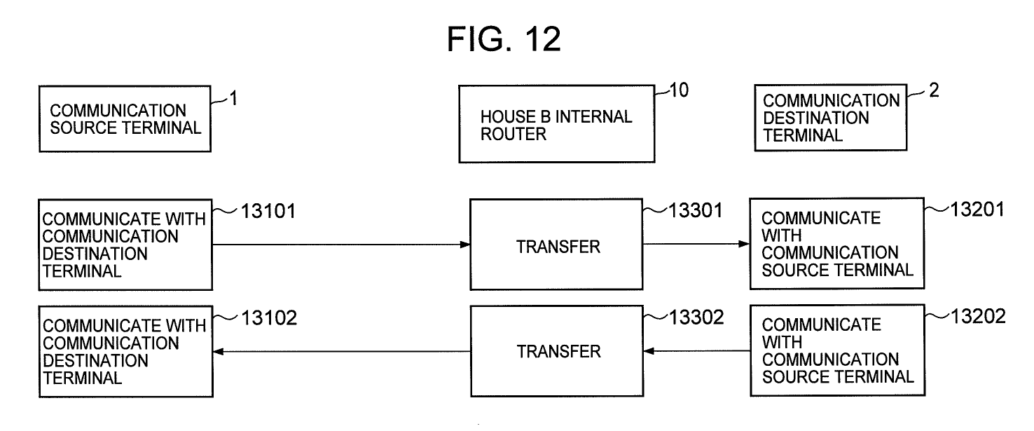

FIG. 12 shows the operation of the communication source terminal 1, the communication destination terminal 2, and the house B internal router 10 when the communication source terminal 1 accesses the communication destination terminal 2 using the location information or similar data list 102 to exchange the audio-, video-, or other communication data 9 with the communication destination terminal 2 in the network system of FIG. 10.

The communication function 106 in the communication source terminal 1 accesses the communication destination terminal 2 using the location information or similar data 8 of the communication destination terminal 2 which is written in the location information or similar data list 102 (Step 13101). In this step, the NAT information about the communication destination terminal 2 is presented to the house B internal router 10. The house B internal router 10 uses the presented information to forward the communication to the communication destination terminal 2 (Step 13301). This step may require additional operation of the communication destination terminal 2, depending on what type of NAT is loaded in the router. Specifics of the additional operation will not be defined in the present invention.

Thus granted access to the communication destination terminal 2, the communication function 106 in the communication source terminal 1 communicates for audio communication, document exchange, or the like with the communication destination terminal 2 in accordance with various parameters necessary for audio or other communication that are written in the location information or similar data 8 (Steps 13201, 13102, 13302, 13202).

Described above is the operation of the network system when the communication source terminal 1 accesses the communication destination terminal 2 using the location information or similar data list 102 to exchange the audio-, video-, or other communication data 9 with the communication destination terminal 2.

The location information or similar data 8 in this embodiment is registered in the house B internal router 10 by the communication destination terminal 2, but the present invention is not limited thereto. For instance, the communication destination terminal 2 may commission the peer-to-peer network participant terminals 4 to register the location information or similar data 8.

The communication destination terminal 2 in this embodiment commissions the house B internal router 10 to register the location information or similar data 8. Alternatively, in the case where a household router, a path controller, or the like are placed in a communication source terminal, the communication source terminal may commission the path controller or the like to conduct a search for location information and receive the result of the search from the path controller or the like that has conducted the search on behalf of the communication source terminal.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A network system, comprising a communication destination machine and a communication source machine that can utilize peer-to-peer network technology,
wherein the communication destination machine includes a unit which registers at least location information of the communication destination machine as location information or similar data in a peer-to-peer network, and
wherein the communication source machine includes:
a unit which searches the peer-to-peer network for the location information or similar data of the communication destination machine and obtains the location information or similar data; and
a unit which uses the obtained information to establish peer-to-peer communication.

2. The network system according to claim 1, wherein the location information or similar data contains communication path information which enables the communication source machine to communicate with a desired machine beyond a path controller.

3. The network system according to claim 1, wherein the location information or similar data contains a parameter necessary for communication.

4. The network system according to claim 1, wherein the communication source machine further includes a unit which accumulates location information or similar data of multiple communication destination machines.

5. A network system, comprising a communication destination machine and a communication source machine that can utilize peer-to-peer network technology,
wherein the communication destination machine is out of a peer-to-peer network,
wherein, in place of the communication destination machine, a machine that can utilize peer-to-peer network technology registers at least location information of the communication destination machine as location information or similar data in the peer-to-peer network, and
wherein the communication source machine includes:
a unit which searches the peer-to-peer network for the location information or similar data of the communication destination machine and obtains the location information or similar data; and
a unit which uses the obtained information to establish peer-to-peer communication.

6. The network system according to claim 5, wherein the location information or similar data contains communication path information which enables the communication source machine to communicate with the communication destination machine beyond a path controller.

7. The network system according to claim 5, wherein the location information or similar data contains a parameter necessary for communication.

8. The network system according to claim 5, wherein the machine that can utilize the peer-to-peer network technology comprises a path controller that controls a path to the communication destination machine.

9. The network system according to claim 5, wherein the communication source machine accumulates location information or similar data of multiple communication destination machines.

10. The network system according to claim 5, wherein the communication source machine conducts a search in place of the machine that is out of the peer-to-peer network, and sends a result of the search to the machine that is out of the peer-to-peer network.
